(19) United States
(12) Patent Application Publication
(10) Pub. No.: US 2016/0087372 A1
(43) Pub. Date: Mar. 24, 2016

(54) STRAIN RELIEF STRUCTURE

(71) Applicant: Caterpillar Inc., Peoria, IL (US)

(72) Inventors: Omar Baba, Peterborough (GB); Rakesh Yarlagadda, Mossville, IL (US); Genaro Ayala, JR., Dunlap, IL (US)

(73) Assignee: Caterpillar Inc., Peoria, IL (US)

(21) Appl. No.: 14/955,045

(22) Filed: Dec. 1, 2015

(51) Int. Cl. H01R 13/58

(52) U.S. Cl. CPC H01R 13/58

(57) ABSTRACT

A strain relief structure is provided. The strain relief structure includes a first end having a trumpet shaped portion, and a second end having a cylindrical portion. The cylindrical portion includes one internal collar projecting from an internal surface of the cylindrical portion at a first predetermined distance from the second end. The cylindrical portion further includes two external collars projecting from an external surface of the cylindrical portion. A first external collar is provided at the second end, and a second external collar is provided at a second predetermined distance from the second end. A slit extends from the first end to the second end along a length of the strain relief structure. The strain relief structure is made of 30% glass filled polyamide 46.

### TECHNICAL FIELD

The present disclosure relates to a strain relief structure, and more specifically, to a strain relief structure for a cable harness of a probe of a sensor, configured to operate in high temperature and high vibration environment.

### BACKGROUND

In automotive engines, various sensors are used to detect exhaust gas constituents. Such sensors may have fragile parts, for example, a cable harness. A cable harness is exposed to bending, stretching as well as various other forms of loads, along with temperature variance and vibration cycles, which may be prejudicial to the reliability of the electrical connections between the sensor and the cable. Cable breakage/failure resulting from incurred harsh angles due to vibrations and high temperature conditions causes the cable to damage even under the protective jacket of the harness. Such failures are desired to be completely eradicated for better reliability of the automotive engine sensors.

To mitigate premature failure of harness, stringent application and installation requirements have been put in place that clearly define harness strain relief requirements through the use of clipping and support points. But on certain installations, these requirements are difficult, and in some cases, impossible to meet due to the lack of space available for permanent rigid fixing points on the machine. Further, stress relief devices for cables are available, which may be attached to the harness for providing strain relief. However, such strain relief devices are not capable of easy fitment after manufacturing of the sensor, and are also not able to sustain the form and the function when they are continuously exposed to temperatures up to 200° C.

U.S. Pat. No. 5,620,334 relates to a stress relief device. The stress relief device includes a clamp and a ring adapted to be screwed to a connector to form a stress relief device that can be removably attached to the rear of the connector. The clamp has two parts: a rear part forming a receptacle and a front part which is open, having a “C” shaped threaded portion with a flexible rear skirt and location bumps for support setup. The material of constructions of the clamp is a composite having elastic properties. However, such a stress relief device is difficult to fit in a manufacturing environment, and has a high risk of damaging cables during a fitment process. Further, such devices are also not capable of operating in high temperature environment without any shielding. Therefore, there is a need for an easy to install strain relief structure which does not fail while operating in high temperature as well as a high vibration environment.

### SUMMARY OF THE DISCLOSURE

In one aspect of the present disclosure, a strain relief structure for a cable harness of a probe of a sensor is provided. The strain relief structure includes a first end having a trumpet shaped portion, and a second end having a cylindrical portion. The cylindrical portion includes at least one internal collar projecting from an internal surface of the cylindrical portion at a first predetermined distance from the second end, the internal collar is structured to couple the strain relief structure to a probe housing of the sensor. The cylindrical portion further includes at least two external collars projecting from an external surface of the cylindrical portion. A first external collar is provided at the second end, and a second external collar is provided at a second predetermined distance from the second end. The strain relief structure further includes a slit extending from the first end to the second end along a length of the strain relief structure. The strain relief structure is made of 30% glass filled polyamide 46.

Other features and aspects of this disclosure will be apparent from the following description and the accompanying drawings.

### BRIEF DESCRIPTION OF THE DRAWINGS

FIG. 1 is a perspective view of a sensor along with a strain relief structure shown in accordance with the concepts of the present disclosure;

FIG. 2 is a perspective view of the strain relief structure in accordance with the concepts of the present disclosure;

FIG. 3 is a top view of the strain relief structure in accordance with concepts of the present disclosure;

FIG. 4 is a front sectional view taken along sectional line 4-4 of FIG. 3 of the strain relief structure in accordance with the concepts of the present disclosure;

FIG. 5 is a cross-sectional view taken along sectional line 5-5 of FIG. 3 of the strain relief structure in assembly with a probe housing, along with a detailed cross-sectional view showing a portion of an interface between the probe housing and the strain relief structure in accordance with the concepts of the present disclosure.

### DETAILED DESCRIPTION

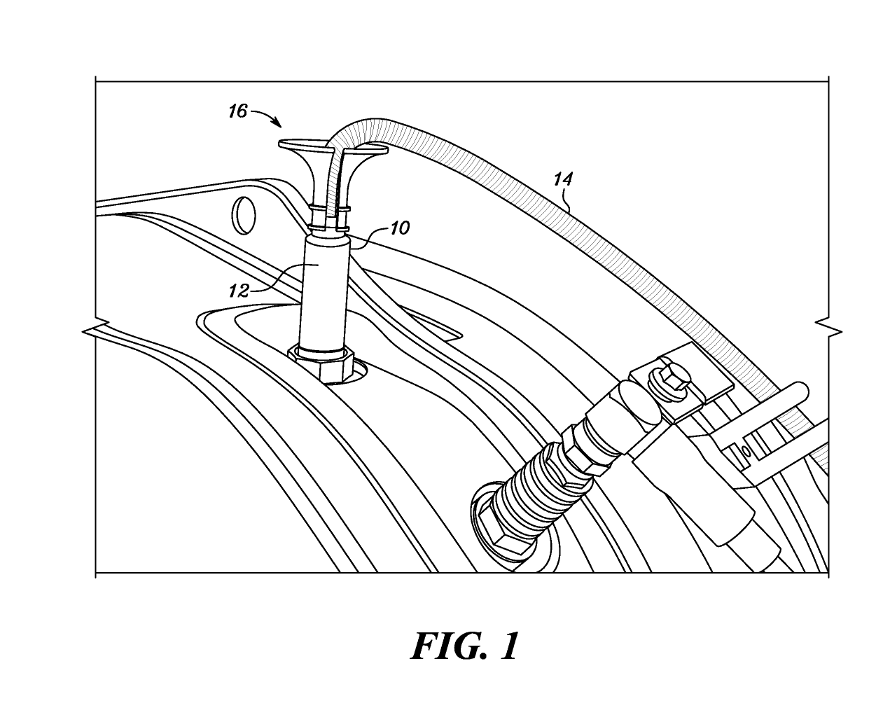

Referring to FIG. 1, a sensor 10 includes a probe (not shown) positioned in a probe housing 12 and a cable harness 14. For the purpose of simplicity, various components of the sensor 10, for example, the mounting flanges or other means for securing the probe housing 12 to the casing of an internal combustion engine are not labeled in FIG. 1. The probe housing 12 is made of stainless steel or any other suitable material. The probe housing 12 is fitted with a strain relief structure 16 to protect the cable harness 14 from harsh bending, and from various other stresses exacerbated by temperature cycling, for example, vibrations.

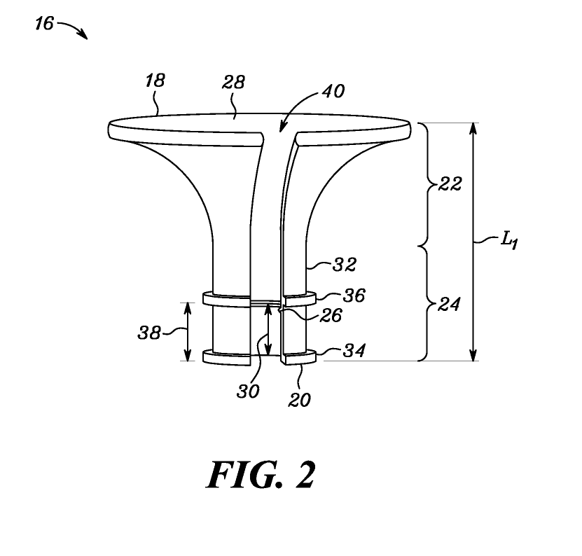

Referring to FIG. 2 the strain relief structure 16 includes a first end 18 and a second end 20. The first end 18 of the strain relief structure 16 includes a trumpet shaped portion 22, and the second end 20 of the strain relief structure 16 includes a cylindrical portion 24. The cylindrical portion 24 includes at least one internal collar 26 projecting from an internal surface 28 at a first predetermined distance 30 from the second end 20, and two external collars projecting from an external surface 32. A first external collar 34 is provided at the second end 20, and a second external collar 36 is provided at a second predetermined distance 38 from the second end 20 of the strain relief structure 16. Optionally, the two external collars accommodate high temperature cable tie (not shown). The strain relief structure 16 further includes a slit 40 extending from the first end 18 to the second end 20 along a length L₁ of the strain relief structure 16. In an embodiment of the present disclosure, the strain relief structure 16 is made of 30% glass filled polyamide 46.

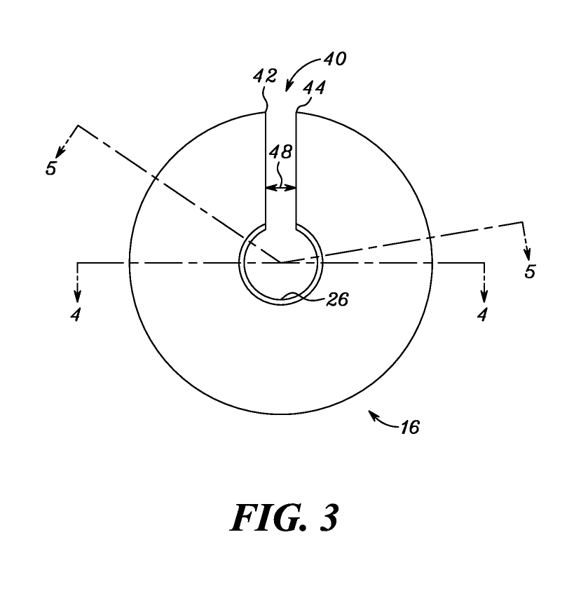

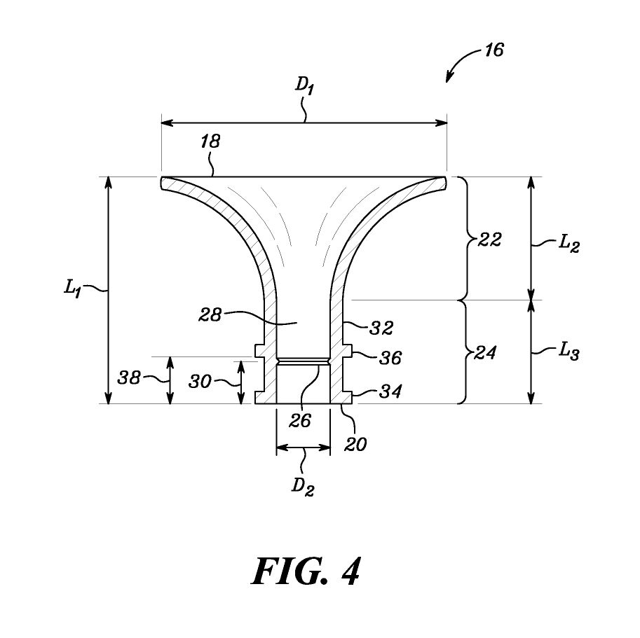

Referring to FIG. 3 and FIG. 4, the strain relief structure 16 has a first edge 42 and a second edge 44 separated by a third predetermined distance 48 forming the slit 40, which extends from the first end 18 to the second end 20 of the strain relief structure 16.

The trumpet shaped portion 22 has a diameter D₁ (FIG. 4) at the first end 18 and a length L₂, the diameter D₁ of the trumpet shaped portion 22 decreases along the length L₂ of the trumpet shaped portion 22 from the first end 18 towards the second end 20. The decreasing diameter of the trumpet shaped portion 22 becomes equal to a diameter D₂ of the cylindrical portion 24 at the end of the length L₂. Further, the length L₂ of the trumpet shaped portion 22 of the strain relief structure 16 is greater than a length L₃ of the cylindrical portion 24 of the strain relief structure 16. In another embodiment, the length L₂ may be equal to or less than the length L₃.

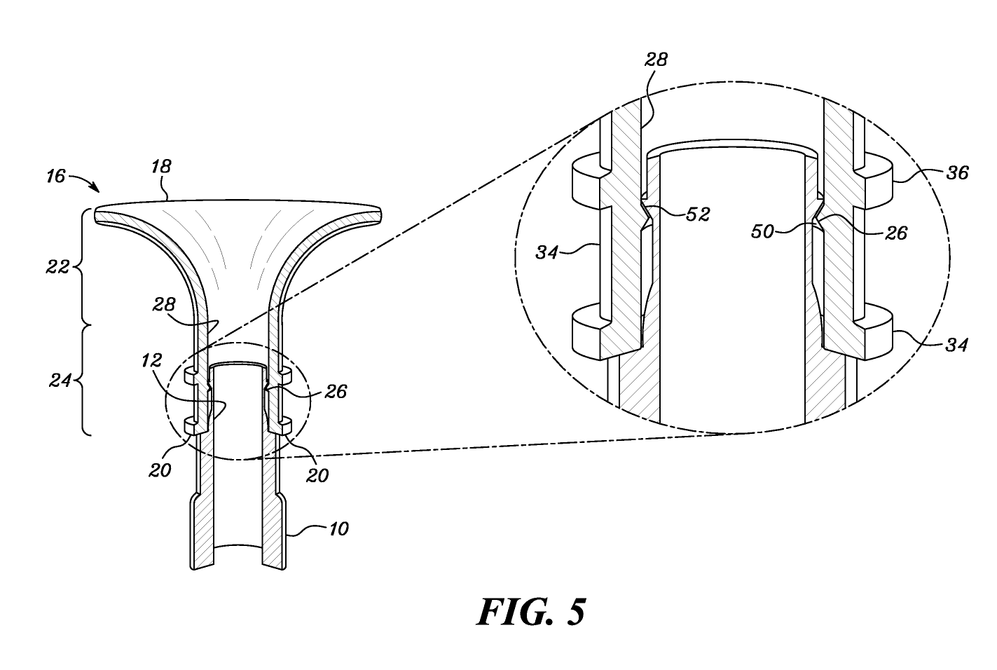

As shown in FIG. 5, the internal collar 26 projecting from the internal surface 28 of the cylindrical portion 24 is structured to couple the strain relief structure 16 to the probe housing 12 of the sensor 10. The internal collar 26 of the cylindrical portion 24 further has a profile 50, which allows coupling between the strain relief structure 16 and the probe housing 12 of the sensor 10. As an example, the sensor 10 includes an indent 52 in the probe housing 12 in which the internal collar 26 may fit, or the probe housing 12 may have a profile complementary to the profile 50 of the internal collar 26 for coupling the strain relief structure 16 with the probe housing 12 of the sensor 10.

In an embodiment, the strain relief structure 16 is utilized in an engine exhaust gas sensor such as but not limited to, a NOₓ sensor and a NH₃ sensor. It will be apparent to one skilled in art that the strain relief structure 16 of the present disclosure may be applied to sensors other than exhaust gas sensors without departing from the scope of the present disclosure.

### INDUSTRIAL APPLICABILITY

In automotive engines, various sensors are used to detect exhaust gas constituents. A cable harness of such sensors is exposed to harsh bending, as well as various other forms of loads, along with stresses exacerbated by temperature cycling, which may result into the breakage/failure of the cable harness. For better reliability of the sensors, the cable harness is protected with the strain relief devices. However, such strain relief devices are not designed to withstand the high temperatures prevalent in the engine exhaust gas environment. Also, the design of existing strain relief structures is not able to provide adequate safety to the cable harness under high vibration conditions.

Referring to FIG. 2, the present disclosure provides the strain relief structure 16 including the trumpet shaped portion 22 and the cylindrical portion 24. The design of the trumpet shaped portion 22 and the cylindrical portion 24 provides adequate support to the cable harness 14 of the trumpet shaped portion 22 and therefore, improved protection under high vibration conditions.

The strain relief structure 16 is designed to retrofit to the existing sensor 10 with the help of the internal collar 26 and requires no changes in design of the sensor 10. Also, the first external collar 34 and the second external collar 36, enable easy fitting of the strain relief structure 16 onto the sensor 10 by a user. Optionally, the two external collars accommodate a high temperature cable tie in case additional fixing is required to withstand harsh vibrations. The slit 40 provided in the strain relief structure 16 enables fitting of the strain relief structure 16 to the sensor 10 without requiring any disconnection of the cable harness 14 and with no risk of damaging wires while fitting the strain relief structure 16. Also, as the material of construction of the strain relief structure 16 is 30% glass filled polyamide 46, the strain relief structure 16 is configured to operate in high temperature and high vibration conditions. Therefore, the strain relief structure 16 is able to sustain the form and the function even when it is continuously exposed to temperatures up to 200° C.

The strain relief structure 16 finds application in sensors having cable harnesses including large numbers of connections. The strain relief structure 16 find applications in a variety of fields including, but not limited to, automobiles, aviation, marine engines, power generators etc.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A strain relief structure for a cable harness of a probe of a sensor, the strain relief structure comprising:
a first end having a trumpet shaped portion; and
a second end having a cylindrical portion, the cylindrical portion includes:
at least one internal collar projecting from an internal surface of the cylindrical portion, the at least one internal collar being located at a first predetermined distance from the second end, and structured to couple the strain relief structure to a probe housing of the sensor;
at least two external collars projecting from an external surface of the cylindrical portion, wherein a first external collar of the at least two external collars is provided at the second end and a second external collar of the at least two external collars is provided at a second predetermined distance from the second end;
a slit extending from the first end to the second end, wherein the slit extends along a length of the strain relief structure, and wherein the strain relief structure is made of 30% glass filled polyamide 46.
